(19) United States
(12) Patent Application Publication
(10) Pub. No.: US 2010/0290157 A1
(43) Pub. Date: Nov. 18, 2010

(54) Damascene coil processes and structures

(75) Inventors: Jinqiu Zhang, Fremont, CA (US); Hongping Yuan, Fremont, CA (US); Hai Sun, Milpitas, CA (US); Ming Zhao, Fremont, CA (US)

Correspondence Address: WESTERN DIGITAL TECHNOLOGIES, INC.;ATTN: LESLEY NING, 20511 LAKE FOREST DR., E-118G, LAKE FOREST, CA, 92630, US

(73) Assignee: Western Digital (Fremont), LLC, Fremont, CA (US)

(21) Appl. No.: 12/466,353

(22) Filed: May 14, 2009

(51) Int. Cl. G11B 5/17; B05D 3/00; B44C 1/22; C25D 5/34

(52) U.S. Cl. 360/123.01; 427/532; 216/22; 205/210; G9B/5.05

(57) ABSTRACT

A magnetic recording head is provided. The magnetic recording head comprises a write pole and a write coil structure configured to generate a magnetic field in the write pole. The write coil structure comprises a substrate layer and a coil material disposed within the substrate layer. The write coil structure is substantially free of photoresist. A method for forming a write coil structure is also provided. The method comprises the steps of providing a substrate layer, forming a photoresist pattern mask over the substrate layer, opening a damascene trench in the substrate layer by reactive ion etching, and disposing a coil material into the damascene trench in the substrate layer.

### FIELD OF THE INVENTION

The present invention generally relates to hard drives and, in particular, relates to damascene coil processes and structures.

### BACKGROUND

Hard disk drives include one or more rigid disks, which are coated with a magnetic recording medium in which data can be stored. Hard disk drives further include read and write heads for interacting with the data in the magnetic recording medium. The write head includes an inductive coil for generating a magnetic field in a write pole, whereby the magnetic moments of domains in the magnetic recording medium are aligned to represent bits of data.

One approach to forming the coil involves patterning a thick layer of photoresist using an I-line stepper, to form a coil shaped cavity in the photoresist into which the coil material will be plated. An I-line stepper is used to provide sufficient depth-of-focus to pattern the photoresist, which may have a thickness of several microns (e.g., as determined by the desired height of the coil's turns). I-line lithography tools, however, suffer from a number of drawbacks, including inferior process control and overlay control. Moreover, this process is less than robust, experiencing around 1% yield loss. Finally, I-line lithography tools have fairly low resolution (compared to other lithography tools), reducing their ability to provide magnetic recording devices with increasingly smaller coil linewidth.

In this approach, after plating the coil material, the patterned resist is stripped away, and another layer of photoresist is provided to cap the coil structure and insulate the turns. The poor overlay capability of the I-line lithography tool often causes insulation coverage problems, which may negatively impact the performance of the coil. The photoresist cap is then cured using a high-temperature bake process that may last for several hours, a process which creates manufacturing challenges (e.g., as the photoresist tends to flow when heated) and may cause product reliability issues.

### SUMMARY OF THE INVENTION

Various embodiments of the present invention solve the foregoing problems by providing improved damascene coils and methods for manufacturing the same. A patterned photoresist layer is used to transfer a coil pattern into one or more hard mask layers, which are then subjected to an etching process to transfer the coil pattern into a substrate, such as alumina or a rigid polymer. Because only a thin layer of photoresist is needed to transfer the coil pattern to the hard mask, higher resolution photolithography equipment (e.g., deep ultraviolet) can be used. Moreover, the substrate into which the coil is plated may be an insulator, obviating the need for a secondary photoresist patterning step and eliminating the insulation coverage problems of other approaches.

According to one embodiment of the subject disclosure, a magnetic recording head comprises a write pole and a write coil structure configured to generate a magnetic field in the write pole. The write coil structure comprises a substrate layer and a coil material disposed within the substrate layer. The write coil structure is substantially free of photoresist.

According to another embodiment of the subject disclosure, a method for forming a write coil structure comprises the steps of providing a substrate layer, forming a photoresist pattern mask over the substrate layer, opening a damascene trench in the substrate layer by reactive ion etching, and disposing a coil material into the damascene trench in the substrate layer.

It is to be understood that both the foregoing summary of the invention and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIGS. 1A-1E illustrate a conventional write coil structure at various steps during the forming thereof;

FIGS. 2A-2G illustrate a write coil structure in accordance with one aspect of the subject disclosure, at various steps during the forming thereof;

FIG. 3 is an atomic force microscopy (AFM) image of a patterned mask used to form a write coil structure in accordance with one aspect of the subject disclosure;

FIG. 4 is a scanning electronic microscopy (SEM) cross-sectional image of an insulating substrate in which damascene trenches have been formed for forming a write coil structure in accordance with one aspect of the subject disclosure;

FIG. 5 is a block diagram illustrating a magnetic recording head in accordance with one aspect of the subject disclosure; and

FIG. 6 is a flow chart illustrating a method for forming a write coil structure in accordance with one aspect of the subject disclosure.

### DETAILED DESCRIPTION OF THE EMBODIMENTS OF THE INVENTION

In the following detailed description, numerous specific details are set forth to provide a full understanding of the present invention. It will be apparent, however, to one ordinarily skilled in the art that the present invention may be practiced without some of these specific details. In other instances, well-known structures and techniques have not been shown in detail to avoid unnecessarily obscuring the present invention.

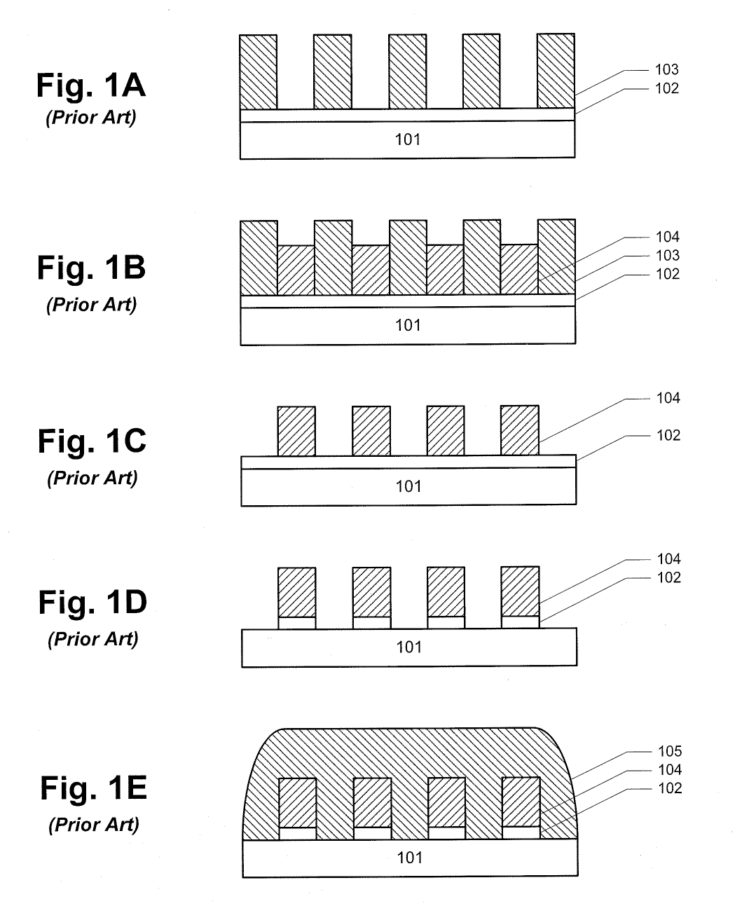

One conventional approach for forming a coil for a magnetic recording head is illustrated in FIGS. 1A to 1E. As can be seen with reference to FIG. 1A, the process begins by patterning a thick layer of photoresist 103 over a seed layer 102 and a substrate 101. The photoresist pattern defines the turns of the coil, and must be at least as high as the height of the turns thereof (e.g., at least 2 μm for many coils, and frequently 3-4 μm). As shown in FIG. 1B, the conductive material of the coil 104 (e.g., Cu) is electroplated into the patterned openings onto the exposed seed layer. The thick photoresist layer may then be stripped away, as is illustrated in FIG. 1C. An etching process may then be employed to remove the excess material from seed layer 102, to fully separate the turns of the coil (e.g., as seed layer 102 may comprise a conductive material). In the last step, another layer of photoresist 105 is patterned over the coil, to insulate the turns from one another and to cap the structure in an insulating material.

As previously set forth, this conventional process suffers from a number of drawbacks, including significant yield loss, low resolution, and insulation coverage problems (e.g., in patterning cap photoresist layer 105). Various embodiments of the subject disclosure overcome these problems, and provide damascene coil structures and processes for making the same that enjoy better yields, higher resolution (and therefore applicability to smaller coil structures), and robust insulation.

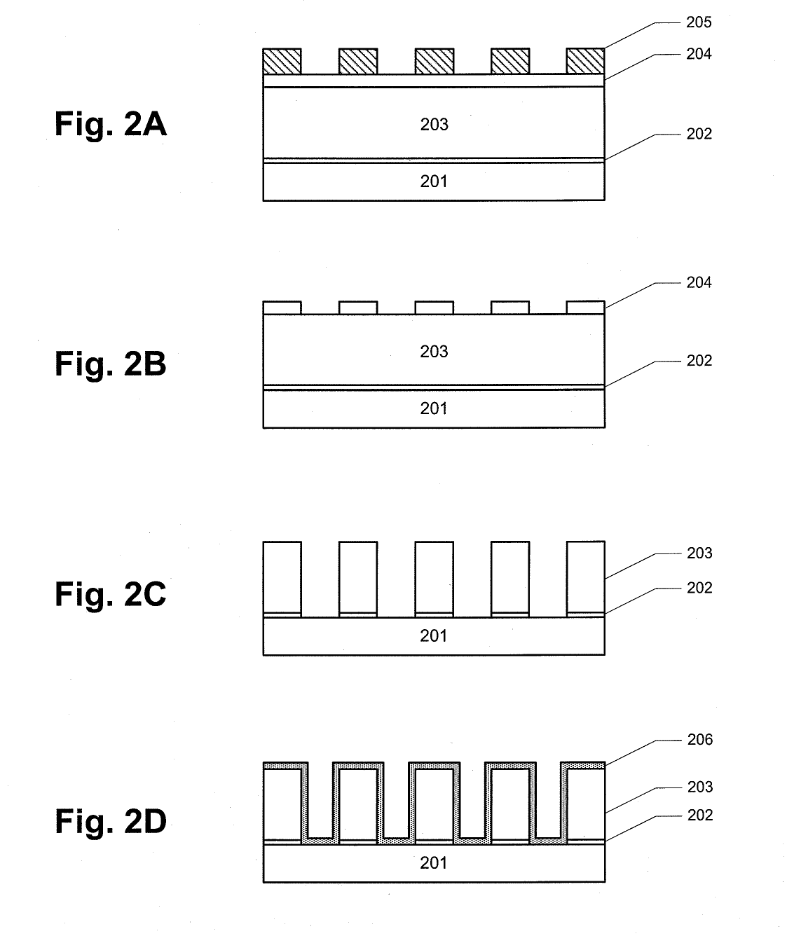

By way of example, FIGS. 2A to 2G illustrate a write coil structure in accordance with one aspect of the subject disclosure, at various steps during the forming thereof. Beginning with FIG. 2A, a thin layer of photoresist 205 (e.g., 0.2-0.3 μm), patterned with the shape of the desired coil structure, is provided over one or more layers of metal 204 (e.g., Ta, Ru, Cr, an alloy thereof, or a multi-layer stack thereof). Metal layer 204 is disposed over a substrate 203 of alumina or a rigid polymer, which in turn is provided over one or more lower substrate layers, such as layers 201 and 202. Because photoresist layer 205 is thin, a lower wavelength photoresist patterning tool (e.g., a deep ultraviolet tool operating between 180 and 360 nm) with higher resolution than an I-line stepper may be used.

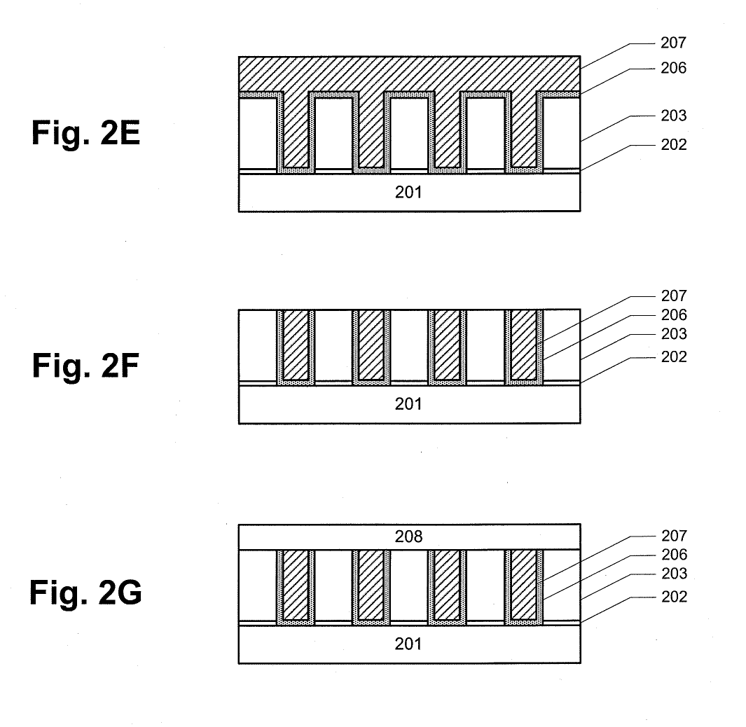

As is illustrated in exemplary FIG. 2B, the pattern from the thin layer of photoresist 205 is transferred to metal layer 204 via an etching process, such as reactive ion etching (RIE), to form a hard mask. An atomic force microscopy (AFM) image of one exemplary hard mask patterned in such a fashion is illustrated in FIG. 3, in accordance with one aspect of the subject disclosure. In this exemplary embodiment, hard mask layer 301 has been provided with a high resolution pattern and with good overlay control, whereby the pattern thereof can be reliably transferred to insulating substrate layer 302, as is set forth in greater detail below.

Returning to FIG. 2C, the hard mask pattern of metal layer 204 is transferred to substrate layer 203 via an etching process, such as RIE. Lower substrate layer 202 may provide an end point detection for this etching process. According to one aspect of the subject disclosure, the etching step used to transfer the pattern from photoresist layer 205 to metal layer 204 may be the same process step used to transfer the pattern from hard mask metal layer 204 to substrate 203. According to another aspect of the subject disclosure, a separate etching step may be used to transfer the pattern from photoresist layer 205 to metal layer 204 than is used to transfer the pattern from hard mask metal layer 204 to substrate 203.

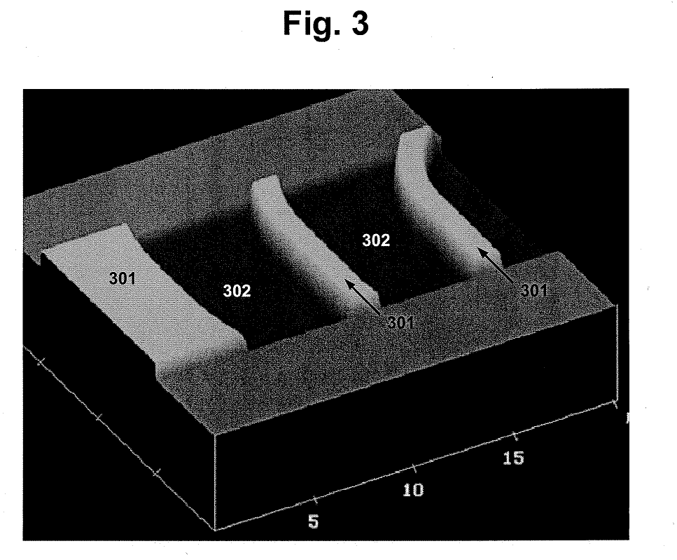

Turning to FIG. 4, a scanning electronic microscopy (SEM) cross-sectional image of an insulating substrate 401 in which damascene trenches 402 have been formed is illustrated in accordance with one aspect of the subject disclosure. As can be seen with reference to FIG. 4, high resolution patterns can be transferred from a hard metal mask to a thick layer of insulating substrate 401, allowing the fabrication of coils with smaller linewidth.

Returning to FIG. 2D, a seed layer 206 is deposited over substrate layer, to facilitate the plating of the coil material into the patterned openings. Seed layer 206 may comprise any one of a number of seed materials, and may optionally be the same material as is used for the coil itself (e.g., Cu). In FIG. 2E, the plating of coil material 207 into the patterned openings is illustrated. The coil material 207 is plated to overfill the patterned openings, such that a subsequent polishing step, such as chemical-mechanical polishing (CMP), can be used to remove the portion of coil material 207 and seed layer 206 which extends above the top of substrate layer 203, as is illustrated in FIG. 2F. A final insulating layer 208 of, for example, alumina or a rigid polymer, can then be provided over the top of the structure to insulate the coil turns from one another and from other conductors.

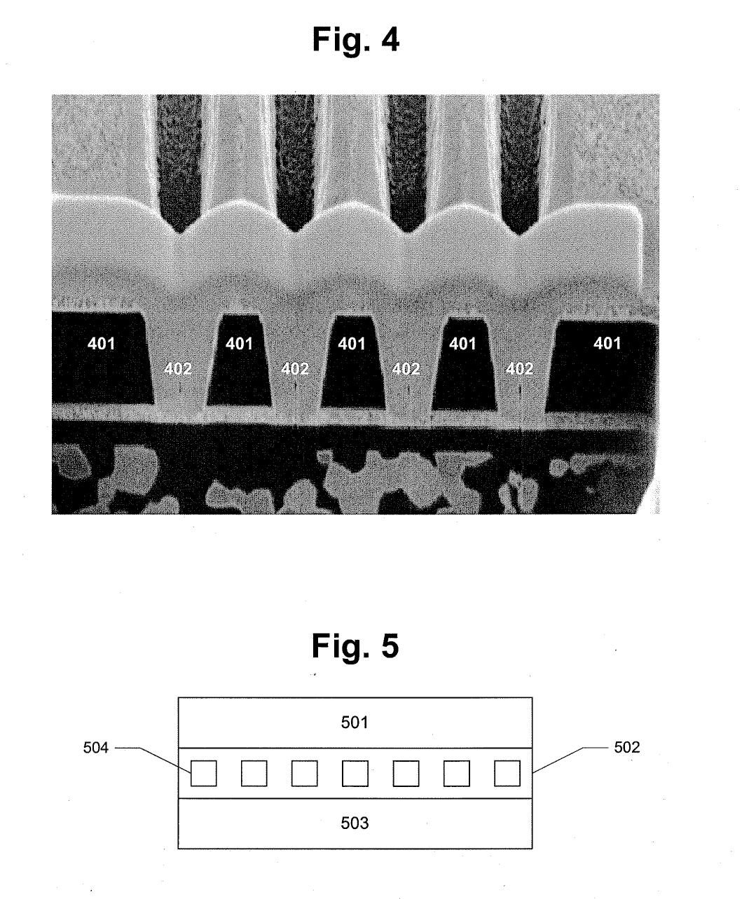

Turning to FIG. 5, a magnetic recording head including a coil structure is illustrated in block diagram format in accordance with one aspect of the subject disclosure. The magnetic recording head comprises a write pole 501, separated from a return pole 503 by a coil layer 502, in which is disposed an inductive coil 504. In this configuration, coil 504 is disposed in a plane parallel to the layer in which write pole 501 is formed. In alternative embodiments, coil 504 may be disposed elsewhere in a magnetic recording head, and with different orientations with respect to a write pole (e.g., perpendicular). By energizing coil 504, a magnetic field can be generated in write pole 501, whereby data can be written to a magnetic recording medium, as will be readily understood by those of skill in the art.

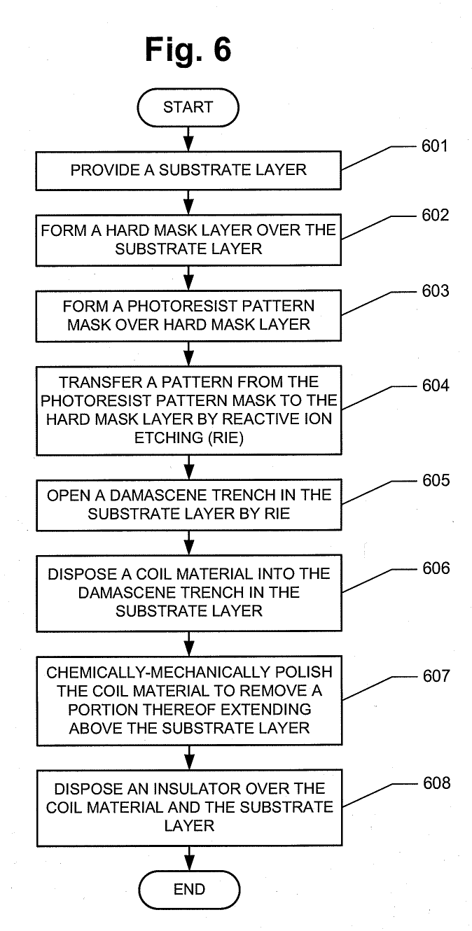

Turning to FIG. 6, a flow chart illustrating a method for forming a write coil structure is depicted in accordance with one aspect of the subject disclosure. The method begins with step 601, in which an insulating substrate layer is provided. The substrate may comprise alumina, a rigid polymer, or the like. In step 602, one or more hard mask layers are formed over the substrate layer. The one or more hard mask layers may comprise any one of a number of metals, including tantalum (Ta), ruthenium (Ru), chromium (Cr) or the like. In step 603, a thin layer of photoresist is formed and patterned over the hard mask layer. According to one exemplary embodiment of the subject disclosure, the photoresist may be only 0.2-0.3 μm thick, and may be patterned using high-resolution deep ultraviolet (DUV) lithography tools. In step 604, the pattern of the photoresist mask is transferred to the hard mask layer by reactive ion etching, or any one of a number of other etching techniques known to those of skill in the art. In step 605, the pattern of the hard mask layer is transferred to the substrate layer to open a damascene trench therein in the shape of the pattern. Step 605 may involve a second, separate etching process from the etching of step 604 or, alternatively, may result from a continuation of the same reactive ion etching process.

In step 606, a coil material is disposed within the damascene trench in the substrate layer. This process may comprise depositing a seed material within the trench and electroplating the coil material over the seed material. Alternatively, any one of a number of other methods for providing a coil material in a damascene trench may be used in step 606. In step 607, the coil material is subjected to a polishing step (e.g., CMP) to remove a portion thereof that extends above the substrate layer. This step may also remove a portion of the seed layer (if one is present), as set forth in greater detail above with reference to FIG. 2F. Finally, in step 608, an insulator is disposed over the coil material and the substrate layer to cap the coil structure and insulate the turns thereof. The insulator may be the same material as the substrate layer (e.g., alumina, a rigid polymer, or the like), or may be a different insulating material.

Various embodiments of the subject disclosure enjoy a number of benefits when compared with other approaches to coil structures in hard disk drives. Because only a thin layer of photoresist is needed to transfer the coil pattern to the hard mask, higher resolution photolithography equipment (e.g., deep ultraviolet) can be used. Moreover, the substrate into which the coil is plated may be an insulator, obviating the need for a secondary photoresist patterning step and eliminating the insulation coverage problems of other approaches.

The description of the invention is provided to enable any person skilled in the art to practice the various embodiments described herein. While the present invention has been particularly described with reference to the various figures and embodiments, it should be understood that these are for illustration purposes only and should not be taken as limiting the scope of the invention.

There may be many other ways to implement the invention. Various functions and elements described herein may be partitioned differently from those shown without departing from the spirit and scope of the invention. Various modifications to these embodiments will be readily apparent to those skilled in the art, and generic principles defined herein may be applied to other embodiments. Thus, many changes and modifications may be made to the invention, by one having ordinary skill in the art, without departing from the spirit and scope of the invention.

A reference to an element in the singular is not intended to mean “one and only one” unless specifically stated, but rather “one or more.” The term “some” refers to one or more. Underlined and/or italicized headings and subheadings are used for convenience only, do not limit the invention, and are not referred to in connection with the interpretation of the description of the invention. All structural and functional equivalents to the elements of the various embodiments of the invention described throughout this disclosure that are known or later come to be known to those of ordinary skill in the art are expressly incorporated herein by reference and intended to be encompassed by the invention. Moreover, nothing disclosed herein is intended to be dedicated to the public regardless of whether such disclosure is explicitly recited in the above description.

We claim:

1. A magnetic recording head comprising:
a write pole; and
a write coil structure configured to generate a magnetic field in the write pole, the write coil structure comprising:
a substrate layer; and
a coil material disposed within the substrate layer,
wherein the write coil structure is substantially free of photoresist.

2. The magnetic recording head of claim 1, wherein the substrate layer comprises alumina (Al₂O₃).

3. The magnetic recording head of claim 1, wherein the substrate layer comprises a rigid polymer.

4. The magnetic recording head of claim 1, wherein the coil material is copper.

5. The magnetic recording head of claim 1, wherein the write coil structure is disposed in a plane parallel to a layer in which the write pole is formed.

6. A hard disk drive comprising the magnetic recording head of claim 1.

7. A method for forming a write coil structure, the method comprising the steps of: providing a substrate layer;
forming a photoresist pattern mask over the substrate layer;
opening a damascene trench in the substrate layer by reactive ion etching; and
disposing a coil material into the damascene trench in the substrate layer.

8. The method of claim 7, further comprising the step of:
forming a hard mask layer over the substrate layer,
wherein the photoresist pattern mask is formed over the hard mask layer.

9. The method of claim 8, further comprising the step of:
transferring a pattern from the photoresist pattern mask to the hard mask layer by reactive ion etching.

10. The method of claim 9, wherein the step of transferring the pattern from the photoresist pattern mask to the hard mask layer comprises the same reactive ion etching as the step of opening a damascene trench in the substrate layer.

11. The method of claim 9, wherein the step of transferring the pattern from the photoresist pattern mask to the hard mask layer comprises a different reactive ion etching process than the step of opening a damascene trench in the substrate layer.

12. The method of claim 7, further comprising the step of:
chemically-mechanically polishing the coil material to remove a portion thereof extending above the substrate layer.

13. The method of claim 7, further comprising the step of:
disposing an insulator over the coil material and the substrate layer.

14. The method of claim 13, wherein the insulator is a same material as the substrate layer.

15. The method of claim 7, wherein the photoresist pattern mask is between about 0.1 and 0.4 microns in thickness.

16. The method of claim 7, wherein the photoresist pattern mask is formed by exposing a portion of the photoresist material forming a desired pattern to electromagnetic radiation between about 180 and 360 nm in wavelength.

17. The method of claim 7, wherein the step of disposing the coil material into the damascene trench comprises the steps of:
depositing a seed material within the damascene trench; and
electroplating the coil material over the seed material.

18. The method of claim 17, wherein the seed material is a same material as the coil material.

19. The method of claim 7, wherein the coil material is copper.

20. The method of claim 7, wherein the hard mask layer comprises one or more of Ta, Ru and Cr.

21. The method of claim 7, wherein the substrate layer comprises alumina or a rigid polymer
